(19) United States
(12) Patent Application Publication
(10) Pub. No.: US 2013/0074876 A1
(43) Pub. Date: Mar. 28, 2013

(54) CLEANING APPARATUS AND CLEANING METHOD FOR COMPONENTS OF METAL ORGANIC CHEMICAL VAPOR DEPOSITION DEVICE

(71) Applicant: JAPAN PIONICS CO., LTD., Kanagawa (JP)

(72) Inventors: Toshio AKIYAMA, Kanagawa (JP); Yuji Mori, Kanagawa (JP)

(73) Assignee: JAPAN PIONICS CO., LTD., Kanagawa (JP)

(21) Appl. No.: 13/624,065

(22) Filed: Sep. 21, 2012

(30) Foreign Application Priority Data
Sep. 28, 2011 (JP) 2011-211714

(51) Int. Cl. B08B 5/02

(52) U.S. Cl. CPC B08B 5/02
USPC 134/32; 134/157

(57) ABSTRACT

A cleaning apparatus a metal organic chemical vapor deposition (MOCVD) device incorporating a susceptor rotatably holding the plurality of substrate holders through a rotating mechanism of a bearing; and a cleaning method for efficiently removing deposits from components of the device. The cleaning apparatus includes storage for the susceptor and the plurality of substrate holders; a means for rotating the susceptor and/or a means for rotating the plurality of substrate holders; a heater; a cleaning gas-introducing port; and a cleaning gas-discharging port. The susceptor holding the plurality of substrate holders is stored in the cleaning apparatus after the device is used for vapor phase epitaxy, and cleaning gas is introduced to the susceptor while the susceptor and/or each of the substrate holders is rotated, so as to remove deposits deposited during vapor phase epitaxy.

### BACKGROUND OF THE INVENTION

1. Field of the Invention

The present invention relates to a cleaning apparatus and a cleaning method for efficiently removing reactant deposited on the components of a metal organic chemical vapor deposition (MOCVD) device during vapor phase epitaxy.

2. Related Art

A metal organic chemical vapor deposition (MOCVD) method has been employed for the crystal growth of a nitride semiconductor as frequently as a molecular beam epitaxy method (MBE method). In particular, the MOCVD method has been widely employed in devices for the mass production of compound semiconductors in the industrial community because the MOCVD method provides a higher crystal growth rate than the MBE method does and obviates the need for a high-vacuum device or the like unlike the MBE method. In recent years, in association with widespread use of blue or ultraviolet LEDs and of blue or ultraviolet laser diodes, numerous researches have been conducted on increases in the diameter and the number of substrates handled by the MOCVD method, in order to improve the mass productivity of the crystal growth of gallium nitride, gallium indium nitride, and gallium aluminum nitride.

Such a MOCVD device has a susceptor for holding a substrate (substrate holders), an opposite face of the susceptor, a heater for heating the substrate, a reactor formed of a gap between the susceptor and the opposite face of the susceptor, a raw material gas-introducing portion for supplying a raw material gas from the central portion of the reactor toward the peripheral portion of the reactor, and a reacted gas-discharging portion, for example, as described in Japanese Unexamined Patent Application Publication Nos. 2002-175992, 2007-96280, 2007-243060, and 2009-99770, and Japanese Patent Application No. 2011-91388. Each of those MOCVD devices is provided with a plurality of substrate holders provided on a susceptor, in which each of the substrate holders rotates and revolves in association with the rotation of the susceptor by the driving means and the rotation-transferring means of a motor or the like. Furthermore, two types of forms, i.e., a form in which a crystal growth surface is directed upward (face-up type) and a form in which a crystal growth surface is directed downward (face-down type) have been mainly proposed as the form of a MOCVD device.

When vapor phase epitaxy is performed by using such a MOCVD device, various kinds of raw material gases are degraded and crystallized on the surface of a substrate heated at a high temperature. However, the substrate holders and the vicinity of the substrate holding portion of the susceptor are heated with a heater, and then raw material gas is reacted to deposit reactant on the surface. Accordingly the amount of the deposited reactant is increased as the growth time or the growth frequency increases. This adversely affects the next crystal growth on the substrate, and thus each of the components is appropriately required to be detached from the MOCVD device for cleaning.

Components of the MOCVD device, such as the substrate holders and the susceptor, are cleaned by contact with cleaning gas in a dedicated cleaning apparatus upon heating, for example, as described in Japanese Unexamined Patent Application Publication Nos. 2006-332201 and 2007-109928.

### SUMMARY OF THE INVENTION

However, as described in Japanese Unexamined Patent Application Publication No. 2002-175992, a MOCVD device incorporating a susceptor rotatably holding a plurality of substrate holders through bearings or incorporating a base plate rotatably holding the susceptor through bearings has a number of bearings as the components. When components of such a device are cleaned by a conventional method of cleaning each component, the problem arises, in which it takes time and work to detach the substrate holders from the susceptor, to install the substrate holders on the susceptor, and the like. Therefore, an object of the present invention is to provide a cleaning apparatus and a cleaning method for efficiently removing deposits (hereafter referred to as “reactant”) from components such as the substrate holders and the susceptor of the above-mentioned MOCVD device after vapor phase epitaxy.

The inventors have made an effort to solve these problems, and have found that a cleaning apparatus for components of the above-mentioned metal organic chemical vapor deposition device, which is provided with a means for rotating the susceptor and a means for rotating each of the substrate holders, can efficiently and easily remove reactant deposited on the susceptor, the substrate holders, the bearings, and the like by introducing cleaning gas while rotating the susceptor and each of the substrate holders, without detaching the susceptor from the base plate or without detaching the substrate holders from the susceptor. Then, the inventors have achieved the cleaning apparatus and the cleaning method for components of a metal organic chemical vapor deposition device of the present invention.

The present invention is a cleaning apparatus for components of a metal organic chemical vapor deposition device incorporating a plurality of substrate holders, a bearing, and a susceptor rotatably holding the plurality of substrate holders through a rotating mechanism of the bearing, including storage for the susceptor and the plurality of substrate holders; a means for rotating the susceptor and/or a means for rotating the plurality of substrate holders; a heater; a cleaning gas-introducing port; and a cleaning gas-discharging port.

The present invention is also a cleaning method for components of a metal organic chemical vapor deposition device, including: storing the susceptor holding the plurality of substrate holders in the cleaning apparatus after the device is used for vapor phase epitaxy; and introducing cleaning gas while rotating the susceptor and/or each of the substrate holders to remove reactant deposited during vapor phase epitaxy.

In the present invention, it is not necessary to disassemble and detach components such as the susceptor, the substrate holders, and the bearing before cleaning or to assemble these components after cleaning, resulting in shortened operation time before and after cleaning. This operation is usually carried out by manpower, but the operation can be omitted in the present invention. Therefore, the cleaning process can be performed by automatic control, and further the components can be cleaned without contact with air, resulting in the efficient removal of reactant.

### BRIEF DESCRIPTION OF THE DRAWINGS

FIG. 1 shows a cross-sectional view illustrating an example cleaning apparatus of the present invention (before the susceptor is stored).

FIG. 2 shows a cross-sectional view illustrating an example cleaning apparatus of the present invention (after the susceptor is stored).

FIG. 3 shows a cross-sectional view illustrating another example cleaning apparatus of the present invention (before the susceptor is stored).

FIG. 4 shows a cross-sectional view illustrating yet another example cleaning apparatus of the present invention (before the susceptor is stored).

FIG. 5 shows a plan view illustrating an example form of the susceptor and the susceptor rotating plate in the present invention.

FIG. 6 shows a plan view illustrating an example form of the substrate holders and the substrate holder rotating plate in the present invention.

### EXPLANATION OF CODES

1 Storage for susceptor and substrate holder
2 Heater
3 Cleaning gas-introducing port
4 Cleaning gas-discharging port
5 Susceptor rotating plate
6 Susceptor rotating shaft
7 Substrate holder rotating plate
8 Substrate holder rotating shaft
9 Base plate holding plate
10 Base plate
11 Susceptor
12 Substrate holder
13 Light transmissive ceramic plate
14 Space for mounting substrate holder

### DETAILED DESCRIPTION OF THE INVENTION

The present invention is applied to a cleaning apparatus and a cleaning method for components of a metal organic chemical vapor deposition device provided with a susceptor rotatably holding a plurality of substrate holders through a bearing. An example of the metal organic chemical vapor deposition device in the present invention performs the crystal growth of a nitride semiconductor formed of a compound of one kind or two or more kinds of metals selected from gallium, indium, and aluminum, and nitrogen. Particularly, the present invention is suitably applied for cleaning components of a metal organic chemical vapor deposition device with a rotating mechanism in which each of the substrate holders is rotated in coordination with the rotation of the susceptor and a metal organic chemical vapor deposition device with a vapor phase epitaxy face being directed downward, in which reactant is hardly deposited the opposite face of the susceptor but easily deposited on the surface of the susceptor.

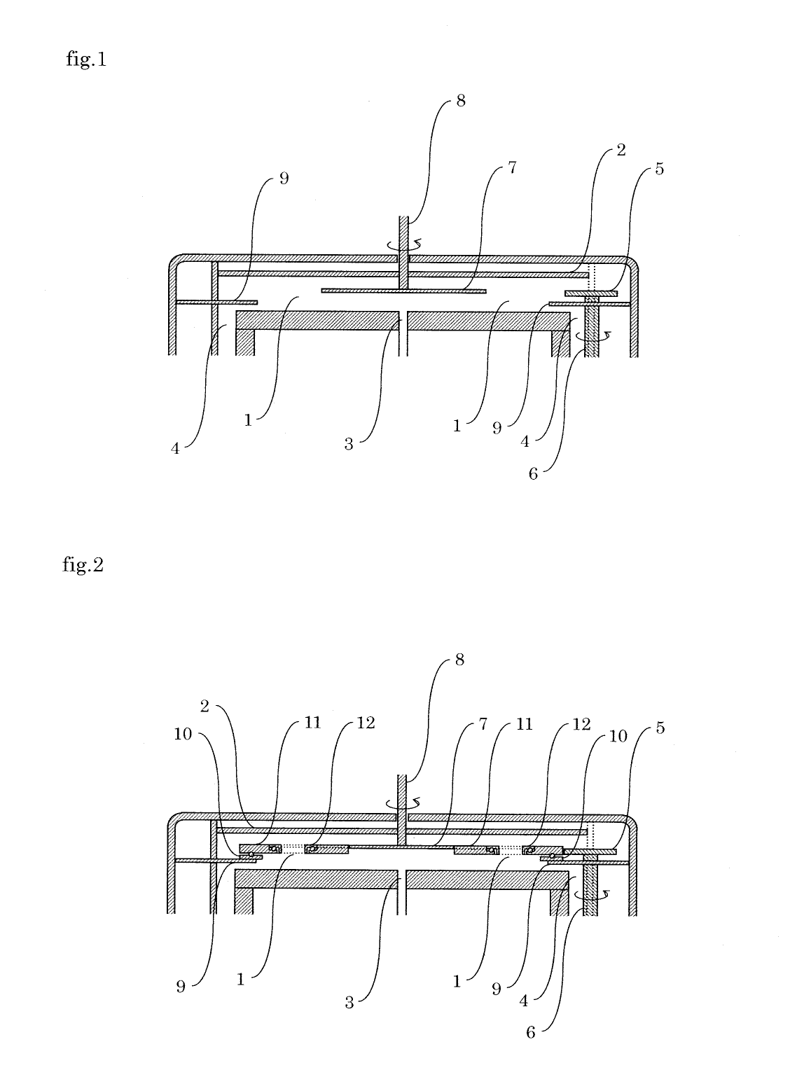

Hereinafter, the cleaning apparatus and the cleaning method of the present invention are described in detail with reference to FIGS. 1 to 6. However, the present invention is not limited by the figures.

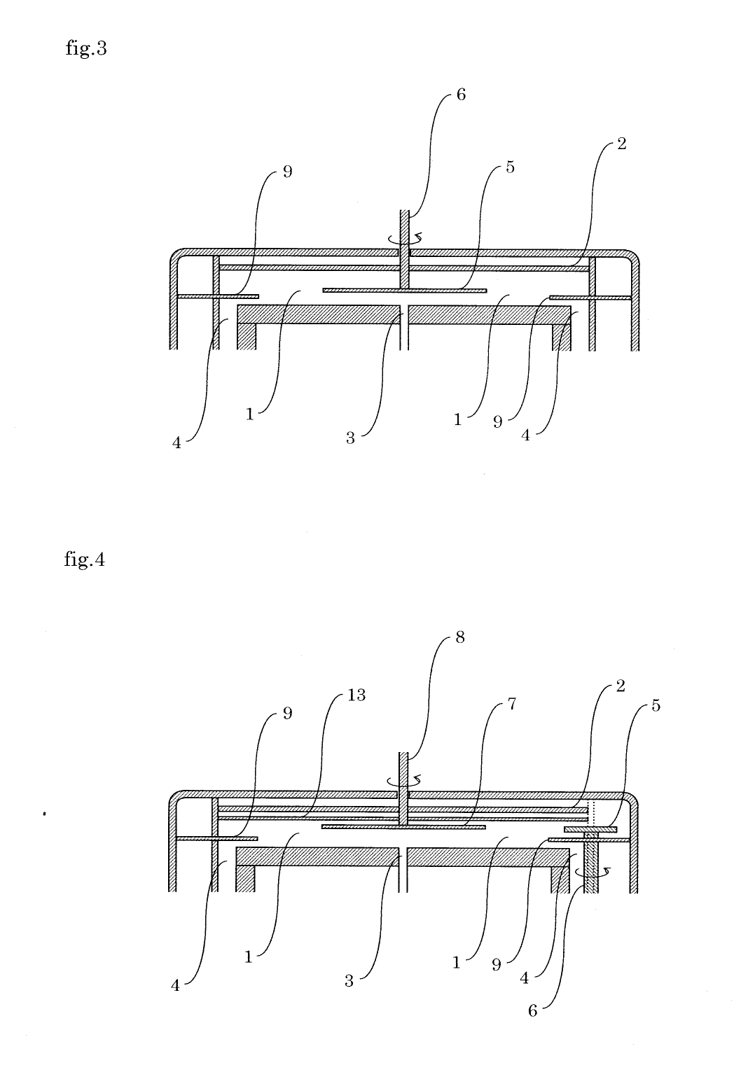

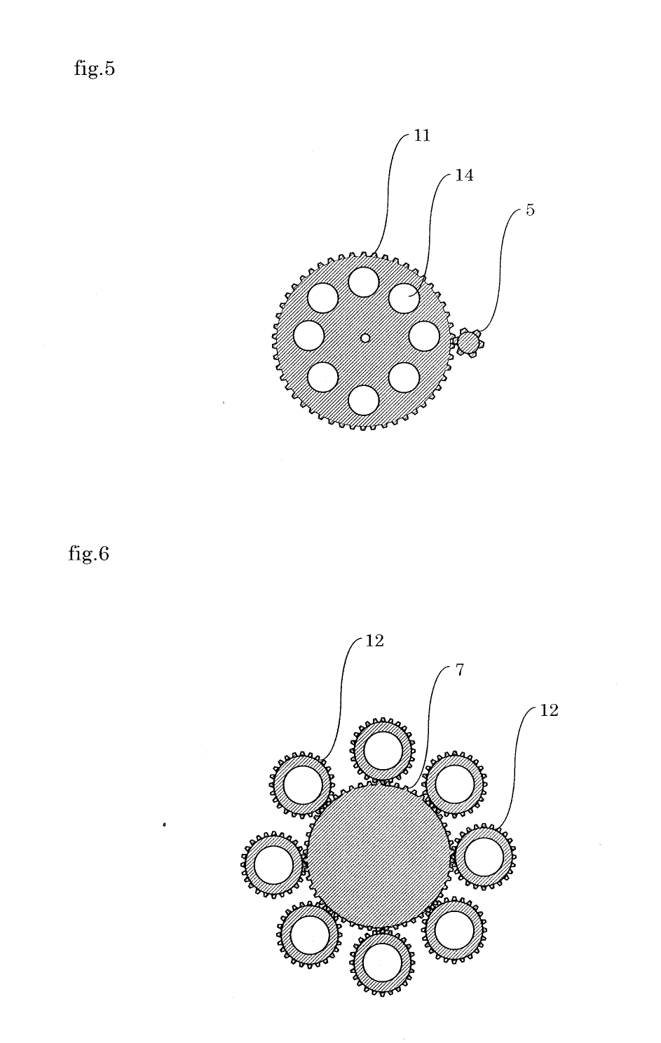

FIG. 1 shows a cross-sectional view illustrating an example cleaning apparatus of the present invention (before the susceptor is stored). FIG. 2 shows a cross-sectional view illustrating an example cleaning apparatus of the present invention (after the susceptor is stored). FIGS. 3 and 4 show cross-sectional views, each of which illustrates an example cleaning apparatus of the present invention (before the susceptor is stored) except that shown in FIG. 1. FIG. 5 shows a plan view illustrating an example form of the susceptor and the susceptor rotating plate in the present invention. FIG. 6 shows a plan view illustrating an example form of the substrate holders and the substrate holder rotating plate in the present invention.

The cleaning apparatus of components of a metal organic chemical vapor deposition device of the present invention has a structure as shown in FIG. 1 before the susceptor to be cleaned is stored and a structure as shown in FIG. 2 after the susceptor to be cleaned is stored. The present invention is a cleaning apparatus for components of a metal organic chemical vapor deposition device incorporating a plurality of substrate holders, a bearing, and a susceptor rotatably holding the plurality of substrate holders through a rotating mechanism of the bearing, as shown in FIG. 5, including: storage 1 for the susceptor and the plurality of substrate holders; a means for rotating the susceptor (rotary drive means such as a susceptor rotating plate 5, a susceptor rotating shaft 6, and a rotary motor) and/or a means for rotating the plurality of substrate holders (rotary drive means such as a substrate holder rotating plate 7, a substrate holder rotating shaft 8, and a rotary motor); a heater 2; a cleaning gas-introducing port 3; and a cleaning gas-discharging port 4, as shown in FIG. 1.

The means for rotating the susceptor in the cleaning apparatus of the present invention will be explained below. In a typical metal organic chemical vapor deposition device, the susceptor rotatably holding a plurality of substrate holders through the rotating mechanism of a bearing has a base plate fixed underneath to the device, which is rotatably holding the susceptor through the rotating mechanism of a bearing, for example, as described in Japanese Unexamined Patent Application Publication No. 2002-175992. The outside rotary drive means rotates a drive gear on the outer peripheral side from the susceptor, causing the susceptor to be rotated through each other's gear teeth. Another example of a metal organic chemical vapor deposition device is provided with a rotary drive shaft in the center for rotating the susceptor, as described in Japanese Unexamined Patent Application Publication No. 2009-99770.

In the present invention, when the susceptor and the like of the metal organic chemical vapor deposition device as described in Japanese Unexamined Patent Application Publication No. 2002-175992 are cleaned, the cleaning apparatus provided with a base plate holding plate 9 (typically, a ring) holding a base plate can be used as shown in FIGS. 1 and 3. In this case, without detaching the susceptor 11 from the base plate 10 or without disassembling components including a bearing, these components are placed on the base plate holding plate 9 as shown in FIG. 2. As shown in FIG. 5, the susceptor 11 with gear teeth along the outer periphery is engaged with the susceptor rotating plate 5 with gear teeth along the outer periphery. During cleaning, the susceptor 11 is rotated by rotative force transferred from a rotary drive means such as a rotary motor (not shown) through the susceptor rotating shaft 6 and the susceptor rotating plate 5. When only the substrate holders rotate and when there is no bearing mechanisms in the lower part of the susceptor, the susceptor may directly be placed on the base plate holding plate 9.

The means for rotating each of the substrate holders in the cleaning apparatus of the present invention will be explained below. The susceptor rotatably holding a plurality of substrate holders through the rotating mechanism of the bearing has a susceptor placed under the plurality of substrate holders, for example, as described in Japanese Patent Application No. 2011-91388. In the present invention, when the substrate holders and the like of such a metal organic chemical vapor deposition device are cleaned, the susceptor rotatably holding the substrate holders is placed on the base plate holding plate 9 without detaching the substrate holders 12 from the susceptor 11 or without disassembling components including the bearing, as shown in FIG. 2. In this case, each of the substrate holders 12 with gear teeth along the outer periphery is engaged with the substrate holder rotating plate 7 with gear teeth along the outer periphery, as shown in FIG. 6. During cleaning, each of the substrate holders 12 is rotated by rotative force transferred from the rotary drive means such as a rotary motor (not shown) through the substrate holder rotating shaft 8 and the substrate holder rotating plate 7.

The metal organic chemical vapor deposition device as described in Japanese Unexamined Patent Application Publication No. 2002-175992 has a rotating mechanism in which each of the substrate holders is rotated in coordination with the rotation of the susceptor. Accordingly, the substrate holder rotating plate 7, the substrate holder rotating shaft 8, or the rotary drive means for rotating these members are not required when the susceptor of such a metal organic chemical vapor deposition device is cleaned. However, a fixed gear for generating the rotation of each of the substrate holders (substrate trays) or a member capable of exerting such an effect is required.

The metal organic chemical vapor deposition device as described in Japanese Unexamined Patent Application Publication No. 2009-99770 has a susceptor rotating plate and a susceptor rotating shaft in the center. When the susceptor of such a metal organic chemical vapor deposition device is cleaned, the substrate holder rotating plate 7 and the substrate holder rotating shaft 8 of the cleaning apparatus of the present invention shown in FIG. 1 can be used as the susceptor rotating plate 5 and the susceptor rotating shaft 6 as shown in FIG. 3. In this case, the susceptor rotating plate 5 or the susceptor rotating shaft 6 shown in FIG. 1, or the rotary drive means for these members is not required.

As shown in FIG. 4, the cleaning apparatus of the present invention can further be provided with a light transmissive ceramic plate 13 between the storage position for the susceptor (substrate holders) and the heater 2. The material of the light transmissive ceramic plate 13 includes quartz and sapphire. The light transmissive ceramic plate is installed in order to protect the heater from cleaning gas with a high temperature. In addition, inert gas such as nitrogen can be introduced in the space between the heater 2 and the light transmissive ceramic plate 13 in order to strengthen the protection of the heater 2. In FIGS. 1 and 3, the cleaning gas-introducing portion 3 is provided in the center of the cleaning apparatus, and the cleaning gas-discharging portion 4 is provided in the peripheral portion of the cleaning apparatus. However, the locations of these portions are not limited to these positions.

The cleaning method for components of a metal organic chemical vapor deposition device of the present invention includes: storing the susceptor holding the plurality of substrate holders in the above-mentioned cleaning apparatus after the device is used for vapor phase epitaxy; and introducing cleaning gas while rotating the susceptor and each of the substrate holders to remove reactant deposited during vapor phase epitaxy.

The type of the cleaning gas used for the cleaning method of the present invention is not limited in particular, but can include hydrogen gas containing chlorine or hydrogen chloride of 0.1-5 vol % and inert gas containing chlorine or hydrogen chloride of 0.1-5 vol %. The temperature of the susceptor and the substrate holder during cleaning is typically 900-1200° C. for the crystal growth of a nitride semiconductor.

### EXAMPLES

The present invention is described specifically by way of Examples. However, the present invention is not limited by these.

### Example 1

### Vapor Phase Epitaxy

A metal organic chemical vapor deposition device of the type described in Japanese Patent Application No. 2011-91388 was used, incorporating a disk-shaped susceptor (made of SiC-coated carbon, having a diameter of 600 mm and a thickness of 20 mm) rotatably holding five substrate holders through the rotating mechanism of a bearing, to grow gallium nitride (GaN) on the respective surfaces of five substrates, each of which is formed of 3 inch-sized sapphires.

Each substrate was cleaned by flowing hydrogen while increasing the temperature of the substrate to 1050° C. Subsequently, the temperature was decreased to 510° C., and then a buffer layer formed of GaN was grown so as to have a thickness of about 20 nm on the substrate by using trimethyl gallium (TMG) and ammonia as raw material gas and by using hydrogen as carrier gas.

After the growth of the buffer layer, the supply of only TMG was stopped, and the temperature was increased to 1050° C. Subsequently, GaN was grown for 3 hours by flowing TMG and ammonia as raw material gas and hydrogen and the like (including nitrogen) as carrier gas to a reaction vessel. All the growths including that of the buffer layer were performed with each substrate rotating at a rotation rate of 10 rpm and with the susceptor rotating at a rotation rate of 1 rpm.

After a nitride semiconductor had been grown in the way as described above, the temperature was decreased, and then the susceptor holding the substrate holders was taken out from the reaction vessel. After that, five substrates were detached.

### Production of Cleaning Apparatus

A cleaning apparatus capable of storing five substrate holders on which a disk-shaped susceptor (made of SiC-coated carbon, having a diameter of 600 mm and a thickness of 20 mm) and five substrates of 3 inches can be placed was produced as shown in FIG. 1. The susceptor rotating plate 5 had a diameter of 80 mm, and the substrate holder rotating plate 7 had a diameter of 200 mm. The base plate holding plate 9 was a ring with an internal diameter of 500 mm and an outer diameter of 700 mm. These members were made of carbon. The susceptor rotating plate 5 is rotated by rotative force transferred from a rotary motor through the susceptor rotating shaft 6. The substrate holder rotating plate 7 is rotated by rotative force transferred from another rotary motor through the substrate holder rotating shaft 8.

Cleaning of Susceptor and Substrate Holders

Then, the susceptor holding the substrate holders after the above-mentioned vapor phase epitaxy was stored in a predetermined position of the cleaning apparatus. Hydrogen gas containing hydrogen chloride of 1 vol % was supplied from the purified gas-introducing portion at a flow rate of 100 L/min with the surface of the susceptor being heated at a temperature of 1050° C. The susceptor and each of the substrate holders were cleaned for 7 hours. During this cleaning, each substrate was rotated at a rotation rate of 10 rpm, and the susceptor was rotated at a rotation rate of 1 rpm.

After the susceptor and each of the substrate holders were cleaned as described above, the temperature was reduced to take out these members from the cleaning apparatus. No reactant was confirmed on the surface of the susceptor. Furthermore, as the result of evaluation of the susceptor and the substrate holders that were disassembled, no reactant was confirmed in these members and on the bearing.

### Example 2

Vapor phase epitaxy was carried out in the same way as that of Example 1. Then, the susceptor and each of the substrate holders were cleaned in the same way as that of Example 1 except that the rotation rate of each substrate holder was 5 rpm and except that the rotation rate of the susceptor was 0.5 rpm. Subsequently, the temperature was reduced to take out these members from the cleaning apparatus. No reactant was confirmed on the surface of the susceptor. Furthermore, as the result of evaluation of the susceptor and the substrate holders that were disassembled, no reactant was confirmed in the inner surface of these members and on the bearing.

### Example 3

Vapor phase epitaxy was carried out in the same way as that of Example 1. Then, the susceptor and each of the substrate holders were cleaned in the same way as that of Example 1 except that the susceptor and each of the substrate holders were cleaned for 4 hours. Subsequently, the temperature was reduced to take out these members from the cleaning apparatus. No reactant was confirmed on the surface of the susceptor. Furthermore, as the result of evaluation of the susceptor and the substrate holders that were disassembled, a little amount of reactant was confirmed in the inner surface of these members and on the bearing.

### Comparative Example 1

Vapor phase epitaxy was carried out in the same way as that of Example 1. On the assumption that the cleaning apparatus without the means for rotating the susceptor or the means for rotating each of the substrate holders would be used, the susceptor and each of the substrate holders were cleaned in the same way as that of Example 1 except that any of the susceptor and the substrate holders were not rotated. No reactant was confirmed on the surface of the susceptor. However, as the result of evaluation of the susceptor and the substrate holders that were disassembled, a large amount of reactant was confirmed in the inner surface of these members and on the bearing.

As described above, without dissembling or detaching components such as the susceptor, the substrate holders, and the bearing, it was confirmed that the cleaning apparatus and the cleaning method of the present invention could clean these members efficiently.

We claim:

1. A cleaning apparatus for components of a metal organic chemical vapor deposition device incorporating a plurality of substrate holders; a bearing, and a susceptor rotatably holding the plurality of substrate holders through a rotating mechanism of the bearing, comprising: storage for the susceptor and the plurality of substrate holders; a means for rotating the susceptor and/or a means for rotating the plurality of substrate holders; a heater; a cleaning gas-introducing port; and a cleaning gas-discharging port.

2. The cleaning apparatus according to claim 1, wherein the means for rotating the susceptor includes a susceptor rotating plate, a susceptor rotating shaft, and a rotary drive means.

3. The cleaning apparatus according to claim 1, wherein the means for rotating the plurality of substrate holders includes a substrate holder rotating plate placed in the center of the cleaning apparatus, a substrate holder rotating shaft, and a rotary drive means.

4. The cleaning apparatus according to claim 1, further comprising a light transmissive ceramic plate between the storage for the susceptor and the heater.

5. The cleaning apparatus according to claim 1, wherein the metal organic chemical vapor deposition device has a rotating mechanism in which each of the substrate holders is rotated in coordination with the rotation of the susceptor.

6. The cleaning apparatus according to claim 1, wherein the metal organic chemical vapor deposition device has a vapor phase epitaxy face being directed downward.

7. A cleaning method for components of a metal organic chemical vapor deposition device according to claim 1, comprising: storing the susceptor holding the plurality of substrate holders in the cleaning apparatus after the device is used for vapor phase epitaxy; and introducing cleaning gas while rotating the susceptor and each of the substrate holders to remove reactant deposited during vapor phase epitaxy.
